(19) United States
(12) Patent Application Publication
(10) Pub. No.: US 2011/0214551 A1
(43) Pub. Date: Sep. 8, 2011

(54) VERTICAL SHAFT MACHINE

(76) Inventor: Bor-Yann CHUANG, Taiping City (TW)

(21) Appl. No.: 12/719,353

(22) Filed: Mar. 8, 2010

(51) Int. Cl. B26D 1/12

(52) U.S. Cl. 83/663

(57) ABSTRACT

A vertical shaft machine includes a base, a blade seat and two sliding seats. The base has a worktable thereon. The blade seat is disposed on the workable. The blade seat has two sides each formed with at least one dovetailed groove. The two sliding seats are respectively disposed at the two sides of the blade seat. Each of the sliding seats includes a dovetailed sliding block which corresponds to the dovetailed groove of the blade seat for the sliding seat to be slid on the blade seat steadily. The sliding seats can resist other pull force and push force except the force from the sliding direction so as to slide on the blade seat steadily, enhancing the processing quality effectively.

### BACKGROUND OF THE INVENTION

1. Field of the Invention

The present invention relates to a vertical shaft machine.

2. Description of the Prior Art

A conventional vertical shaft machine includes a base. The top of the base has a worktable. The worktable is provided with a blade seat thereon. Two sides of the blade seat are connected with a sliding seat, respectively. A front end of the sliding seat is provided with a stop board for a workpiece to lean against the stop board. A rear end of the sliding seat is provided with an adjusting screw to adjust the position of the sliding seat relative to the blade seat so as to adjust the feed quantity of processing. However, the sliding seat of the conventional vertical shaft machine slides on the side of the blade seat through at least one guide rod to guide the sliding direction of the sliding seat. In this way, the sliding seat is easily shaken by other forces during processing, which may influence the flatness of the processing surface of the workpiece. It is necessary to improve this shortcoming.

### SUMMARY OF THE INVENTION

The present invention is to provide a vertical shaft machine which includes a base, a blade seat and two sliding seats. The base has a worktable thereon. The blade seat is disposed on the workable. The blade seat has two sides each formed with at least one dovetailed groove. The two sliding seats are respectively disposed at the two sides of the blade seat. Each of the sliding seats includes a dovetailed sliding block which corresponds to the dovetailed groove of the blade seat for the sliding seat to be slid on the blade seat steadily. Through the engagement of the dovetailed sliding block and the dovetailed groove, the sliding seats can resist other pull force and push force except the force from the sliding direction so as to slide on the blade seat steadily, enhancing the processing quality effectively.

### BRIEF DESCRIPTION OF THE DRAWINGS

FIG. 1 is a perspective view according to a preferred embodiment of the present invention;

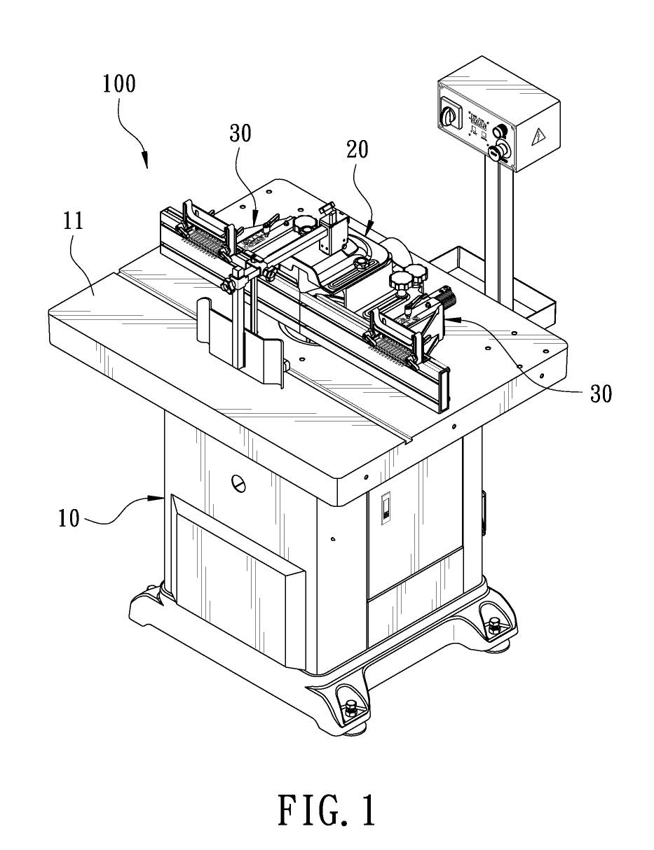

FIG. 2 is a partially enlarged view according to the preferred embodiment of the present invention;

FIG. 3 is a partially exploded view according to the preferred embodiment of the present invention;

FIG. 4 is a partially cross-sectional view to show the engagement of the adjusting bolt according to the preferred embodiment of the present invention;

FIG. 5 is a partially cross-sectional view to show the connection of the sliding seat and the blade seat according to the preferred embodiment of the present invention; and

FIG. 6 is a schematic view showing the operation of the preferred embodiment of the present invention.

### DETAILED DESCRIPTION OF THE PREFERRED EMBODIMENTS

Embodiments of the present invention will now be described, by way of example only, with reference to the accompanying drawings.

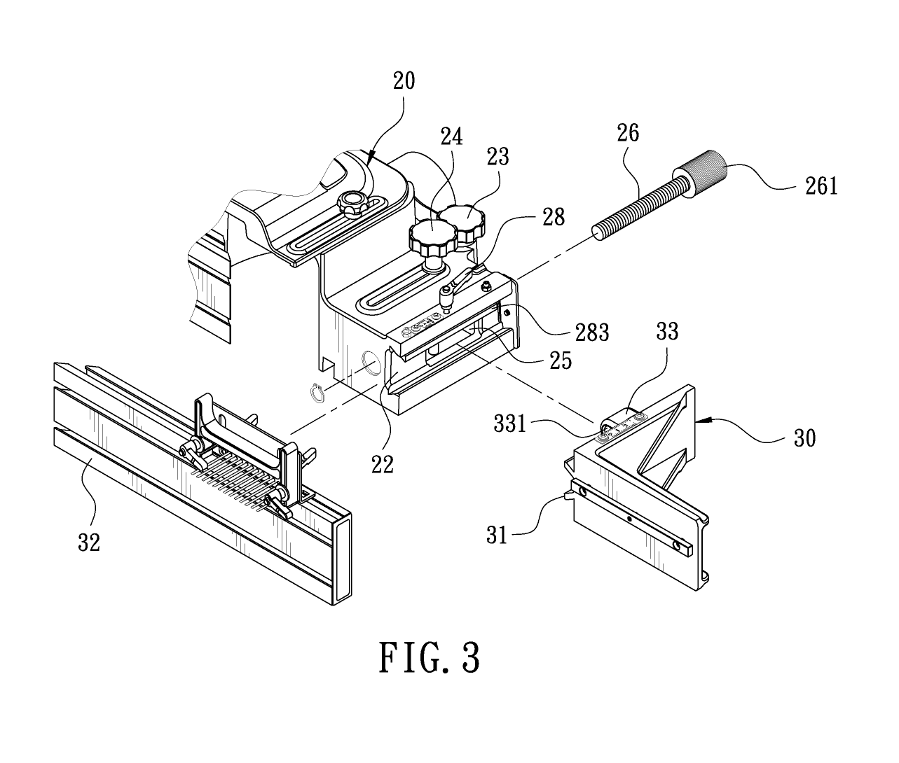

As shown in FIG. 3, a vertical shaft machine 100 according to a preferred embodiment of the present invention comprises a base 10, a blade seat 20 and two sliding seats 30.

The top of the base 10 is provided with a worktable 11. The worktable 11 includes at least two guide racks 12 thereon. The two guide racks 12 are parallel to each other. At least one of the guide racks 12 is provided with a guide member 13. One side of the guide member 13 is formed with a teeth portion 131 which is axially disposed along the guide rack 12. In this embodiment, the worktable 11 is provided with two guide racks 12. The top of the guide rack 12 at the right side of the worktable 11 is provided with the guide member 13. One side of the guide member 13, opposite to the other guide rack 12, is formed with the teeth portion 131.

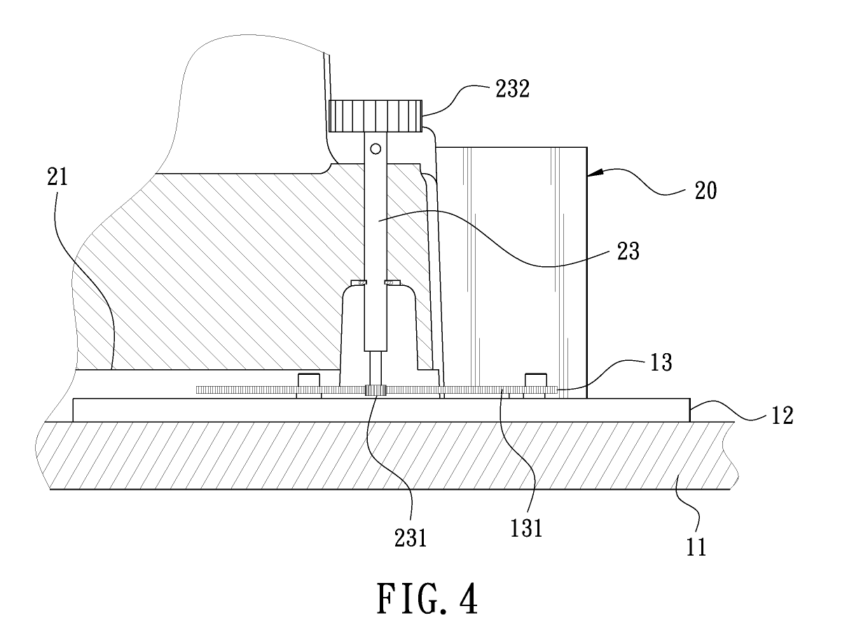

The blade seat 20 has a bottom formed with two guide grooves 21 corresponding to the guide racks 12 of the base 10. The blade seat 20 is movably slid on the worktable 11. The blade seat 20 has two sides each formed with at least one dovetailed groove 22. The blade seat 20 is pivotally connected with an adjusting bolt 23 corresponding to the guide member 13 of the guide rack 12. Referring to FIG. 4, one end of the adjusting bolt 23 is provided with a gear 231. The gear 231 is adapted to engage with the teeth portion 131 of the guide member 13. Another end of the adjusting bolt 23 is exposed out of the blade seat 20 and connected with a knob 232. When the adjusting bolt 23 is adjusted, the blade seat 20 will be driven to move along the guide rack 12. The blade seat 20 has a top which is pivotally connected with at least two bolts 24 to lock the blade seat 20 on the worktable 11.

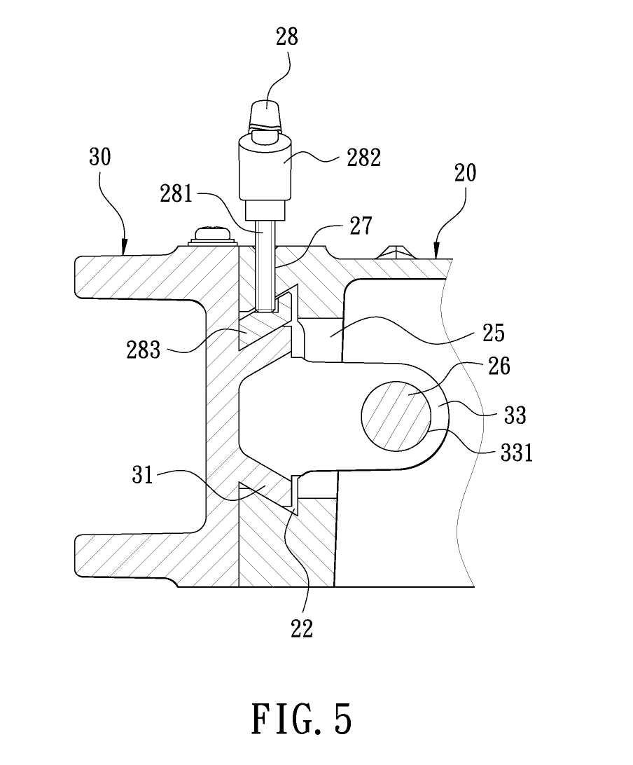

The two sliding seats 30 are respectively disposed at the two sides of the blade seat 20. Each sliding seat 30 includes a dovetailed sliding block 31 which protrudes from one side thereof and corresponds to the dovetailed groove 22 of the blade seat 20 for the sliding seat 30 to be slid on the blade seat 20 steadily. A front end of each sliding seat 30 is transversally provided with a stop board 32. Referring to FIG. 5, each sliding seat 30 is provided with a driving block 33 which faces the blade seat 20. The driving block 33 is axially formed with a threaded hole 331. Each of the two sides of the blade seat 20 is formed with a limit recess 25 corresponding to the driving block 33. The threaded hole 331 of the driving block 33 is adapted to engage with an adjusting screw 26. One end of the adjusting screw 26, opposite to the stop board 32 of the sliding seat 30, is exposed out of the blade seat 20 and connected with an adjusting member 261 for turning the adjusting screw 26 to drive the sliding seat 30 to slide along the dovetailed groove 22.

Referring to FIG. 5, a gap is defined between a top surface of the dovetailed sliding block 31 and an inner wall of the dovetailed groove 22. The top of the blade seat 20 is formed with two through holes 27 which are located close to the dovetailed grooves 22 and intercommunicated with the dovetailed grooves 22, respectively. Each through hole 27 is inserted with a fastening member 28. The fastening member 28 includes a rod 281 inserting in the through hole 27. One end of the rod 281 is exposed out of the top of the blade seat 20 and connected with a control handle 282. Another end of the rod 281 is extended in the gap and connected with a tightening block 283. The tightening block 283 has two sides which are parallel to the inner wall of the dovetailed groove 22 and the top surface of the sliding block 31 to be against the inner wall of the dovetailed groove 22 and the top surface of the sliding block 31.

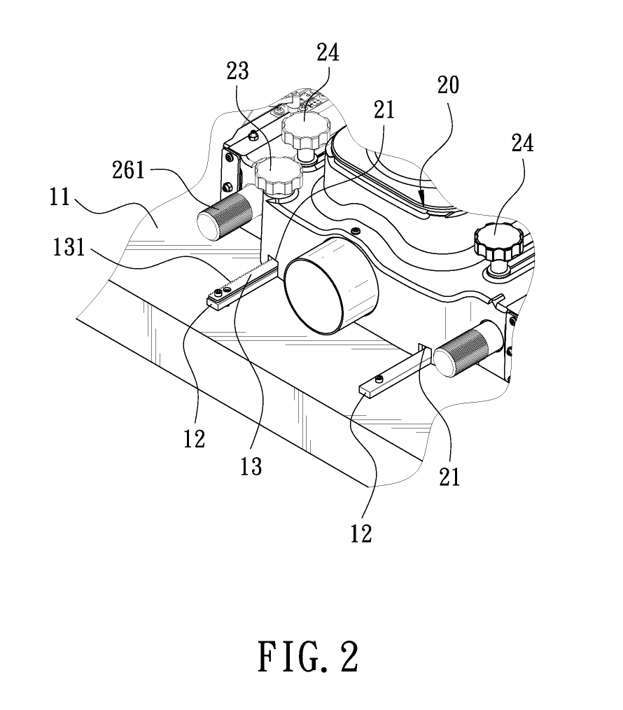

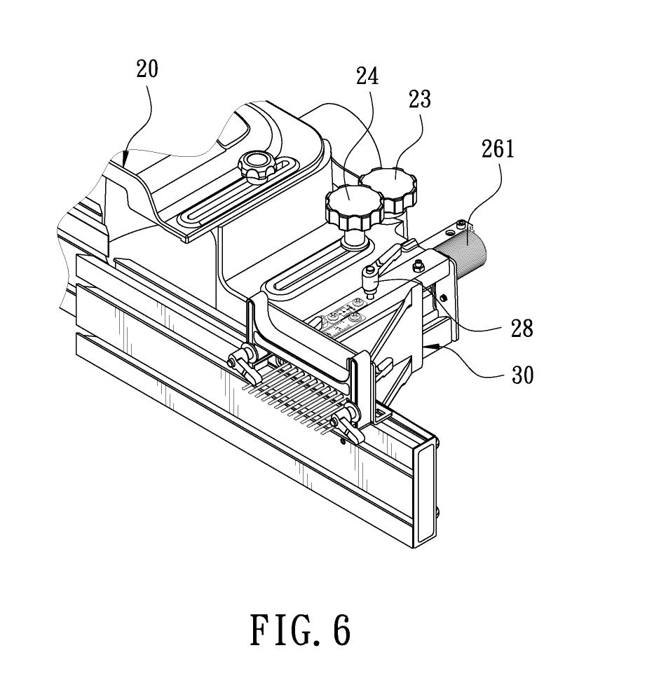

Referring to FIG. 3 to FIG. 5, through the engagement of the dovetailed sliding block 31 and the dovetailed groove 22, the sliding seats 30 can resist other pull force and push force except the force from the sliding direction so as to slide on the blade seat 20 steadily. During the operation of the vertical shaft machine 100, it would not be shaken easily so as to maintain the flatness of the processing surface of the processing workpiece and to enhance the processing quality effectively. Besides, when the user wants to adjust the position of the sliding seat 30, the adjusting member 261 can be turned to drive the adjusting screw 26, so that the sliding seat 30 is slid along the dovetailed groove 22, as shown in FIG. 6. After the adjustment is finished, the control handle 282 of the fastening member 28 is turned for the tightening block 283 to lean against the sliding block 31 of the sliding seat 30, such that the sliding seat 30 is secured on the blade seat 20. As shown in FIG. 4, when the user wants to adjust the blade seat 20, the knob 232 can be turned to drive the adjusting bolt 23 to turn the gear 231, such that the blade seat 20 is steadily moved along the guide rack 12 along with the sliding seat 30. After the adjustment is finished, the bolts 24 are turned to secure the blade seat 20 on the worktable 11, as shown in FIG. 2. The vertical shaft machine 100 of the present invention can steadily and quickly adjust the positions of the blade seat and the sliding seats according to the demand of the workpiece.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A vertical shaft machine, comprising:
a base having a worktable thereon;
a blade seat disposed on the worktable, the blade seat having two sides each formed with at least one dovetailed groove; and
two sliding seats respectively disposed at the two sides of the blade seat, each of the sliding seats including a dovetailed sliding block which corresponds to the dovetailed groove of the blade seat for the sliding seat to be slid on the blade seat steadily.

2. The vertical shaft machine as claimed in claim 1, wherein a gap is defined between a top surface of the dovetailed sliding block and an inner wall of the dovetailed groove, the blade seat having a top formed with two through holes which are located close to the dovetailed grooves and intercommunicated with the dovetailed grooves respectively, each of the through holes being inserted with a fastening member, the fastening member including a rod which is inserted in the through hole, one end of the rod being exposed out of the top of the blade seat and connected with a control handle, another end of the rod being extended in the gap and connected with a tightening block, the tightening block having two sides which are parallel to the inner wall of the dovetailed groove and the top surface of the dovetailed sliding block to be against the inner wall of the dovetailed groove and the top surface of the dovetailed sliding block.

3. The vertical shaft machine as claimed in claim 1, wherein each of the sliding seats is provided with a driving block which faces the blade seat, the driving block being axially formed with a threaded hole, each of the two sides of the blade seat being formed with a limit recess corresponding to the driving block, the threaded hole of the driving block being adapted to engage with an adjusting screw, one end of the adjusting screw being exposed out of the blade seat and connected with an adjusting member for turning the adjusting screw to drive the sliding seat to slide along the dovetailed groove.

4. The vertical shaft machine as claimed in claim 1, wherein the worktable includes two guide racks thereon, the two guide racks being parallel to each other, the blade seat having guide grooves corresponding to the guide racks for the blade seat being slid on the worktable.

5. The vertical shaft machine as claimed in claim 4, wherein at least one of the guide racks is provided with a guide member, one side of the guide member being formed with a teeth portion which is axially disposed along the guide rack, the blade seat being pivotally connected with an adjusting bolt corresponding to the guide member, one end of the adjusting bolt being provided with a gear, the gear being adapted to engage with the teeth portion of the guide member, another end of the adjusting bolt being exposed out of the blade seat and connected with a knob, by adjusting the adjusting bolt, the blade seat being driven to move along the guide rack.

6. The vertical shaft machine as claimed in claim 1, wherein the blade seat is pivotally connected with at least two bolts to lock the blade seat on the worktable.
